(19) United States
(12) Patent Application Publication
(10) Pub. No.: US 2024/0098596 A1
(43) Pub. Date: Mar. 21, 2024

(54) COMMUNICATION SYSTEM, BASE STATION, AND COMMUNICATION METHOD

(71) Applicant: Toyota Jidosha Kabushiki Kaisha, Toyota-shi Aichi-ken (JP)

(72) Inventors: Lei ZHONG, Chuo-ku Tokyo-to (JP); Jing MA, Yokohama-shi Kanagawa-ken (JP); Xiao SHAO, Kawasaki-shi Kanagawa-ken (JP)

(73) Assignee: Toyota Jidosha Kabushiki Kaisha, Toyota-shi Aichi-ken (JP)

(21) Appl. No.: 18/242,593

(22) Filed: Sep. 6, 2023

(30) Foreign Application Priority Data
Sep. 15, 2022 (JP) 2022-147340

(51) Int. Cl. H04W 36/08; H04W 36/00

(52) U.S. Cl. CPC H04W 36/087; H04W 36/0061

(57) ABSTRACT

A communication system comprising a first base station that includes a first controller and a second base station that includes a second controller, wherein the first controller is configured to transmit a handover request to the second base station in a case where handover of a user terminal to the second base station is required, the second controller is configured to transmit a handover response to the first base station in response to reception of the handover request, the handover response including a renewable energy use rate of the second base station, and the first controller is configured to transmit a handover command to the user terminal in response to reception of the handover response, the handover command including the renewable energy use rate or a data transmission control command according to the renewable energy use rate.

### CROSS REFERENCE TO THE RELATED APPLICATION

This application claims the benefit of Japanese Patent Application No. 2022-147340, filed on Sep. 15, 2022, which is hereby incorporated by reference herein in its entirety.

### BACKGROUND

### Technical Field

The present disclosure relates to communication control of a communication system.

### Description of the Related Art

These days, renewable energy is gaining attention, and use of renewable energy by a base station is beginning to spread.

If a base station with a higher use rate of renewable energy is to perform more communication, and a base station with a lower use rate is to perform less communication, the use rate of renewable energy of the entire communication system may be expected to increase.

However, current communication control of a communication system is performed regardless of whether renewable energy is used or not (Non Patent Literatures 1 to 3), and it is difficult to increase the use rate of renewable energy of the entire communication system.

### CITATION LIST

### Non-Patent Literature

Non-Patent Literature 1: 3GPP TS 38.300 9.2.3
Non-Patent Literature 2: 3GPP TS 23.502 4.9.1.3
Non-Patent Literature 3: 3GPP TS 38.331 5.3.3

### SUMMARY

An aspect of the present disclosure is aimed at providing a technique that is capable of increasing a use rate of renewable energy of an entire communication system.

One aspect of the disclosure is a communication system comprising a first base station that includes a first controller and a second base station that includes a second controller, wherein the first controller is configured to transmit a handover request to the second base station in a case where handover of a user terminal to the second base station is required, the second controller is configured to transmit a handover response to the first base station in response to reception of the handover request, the handover response including a renewable energy use rate of the second base station, and the first controller is configured to transmit a handover command to the user terminal in response to reception of the handover response, the handover command including the renewable energy use rate or a data transmission control command according to the renewable energy use rate.

Another aspect of the disclosure is a communication method comprising: a step, performed by a first base station, of transmitting a handover request to a second base station in a case where handover of a user terminal to the second base station is determined to be necessary; a step, performed by the second base station, of transmitting a handover response to the first base station in response to reception of the handover request, the handover response including a renewable energy use rate of the second base station; and a step, performed by the first base station, of transmitting a handover command to the user terminal in response to reception of the handover response, the handover command including the renewable energy use rate or a data transmission control command according to the renewable energy use rate.

Yet another aspect of the disclosure is a communication method comprising: a step, performed by a first base station, of transmitting a handover request to a second base station in a case where handover of a user terminal to the second base station is determined to be necessary; a step, performed by the second base station, of transmitting a handover response to the first base station in response to reception of the handover request, the handover response including a renewable energy use rate of the second base station; and a step, performed by the first base station, of transmitting a handover command to the user terminal in response to reception of the handover response, the handover command including the renewable energy use rate or a data transmission control command according to the renewable energy use rate.

Yet another aspect of the disclosure is a communication method comprising a step of causing a user terminal to perform selection of a base station or control of data transmission based on a renewable energy use rate, based on notification of the renewable energy use rate to the user terminal by a base station.

According to an aspect of the present disclosure, a use rate of renewable energy of an entire communication system may be increased.

### BRIEF DESCRIPTION OF THE DRAWINGS

FIG. 1 is a diagram illustrating an example of a system configuration of a communication system according to a first embodiment;

FIG. 2 is a diagram illustrating an example of a handover process according to the first embodiment;

FIG. 3 is a diagram illustrating another example of the handover process according to the first embodiment;

FIG. 4 is a diagram illustrating an example of a connection process at a time of activation of a user terminal according to a second embodiment;

FIG. 5 is a diagram illustrating an example of a connection process of the user terminal to a base station according to a third embodiment; and

FIG. 6 is a diagram illustrating an example of a setting change process for wireless connection according to a fourth embodiment.

### DESCRIPTION OF THE EMBODIMENTS

An embodiment of the present disclosure is a communication system including a first base station that includes a first controller, and a second base station that includes a second controller.

In a case where handover of a user terminal to the second base station is required, the first controller of the first base station transmits a handover request to the second base station. Whether handover is required or not may be determined based on a reception strength related to a base station in a neighborhood of the user terminal that is transmitted from the user terminal, and handover to the second base station may be determined to be necessary in a case where the reception strength of a signal from the second base station exceeds a threshold (for example, the threshold is the reception strength of a signal from the first base station). The handover request may be directly transmitted from the first base station to the second base station or may be transmitted from the first base station to the second base station via another apparatus (such as a core network) or after being processed.

The second controller of the second base station transmits a handover response to the first base station in response to reception of the handover request, the handover response including a renewable energy use rate of the second base station. The renewable energy use rate may be in any form as long as it is information that indicates how much of energy used by the second base station is renewable energy.

Furthermore, the renewable energy use rate included in the handover response may be based on an actual value of the renewable energy use rate of the second base station at or up to a time point of transmission of the handover response. Furthermore, the renewable energy use rate included in the handover response may be based on a predicted value of the renewable energy use rate of the second base station after the time point of transmission of the handover response. Moreover, the renewable energy use rate included in the handover response may be based on both the actual value and the predicted value. The handover response may be directly transmitted from the second base station to the first base station or may be transmitted from the second base station to the first base station via another apparatus (such as the core network) or after being processed.

The first controller of the first base station transmits a handover command to the user terminal in response to reception of the handover response from the second base station. The handover command here includes the renewable energy use rate or a data transmission control command according to the renewable energy use rate. For example, the data transmission control command may include information indicating at how much data transmission rate or data transmission amount the user terminal will perform communication after handover to the second base station. At how much data rate or data amount the communication is performed may be determined based on the renewable energy use rate of the second base station. The handover command may be directly transmitted from the first base station to the user terminal or may be transmitted from the first base station to the user terminal via another apparatus (such as the core network) or after being processed.

In response to the handover command from the first base station, the user terminal switches a connection target from the first base station to the second base station. After handover from the first base station to the second base station, the user terminal performs communication using a data rate or data amount that is according to the data transmission control command or a data rate or data amount that is according to the renewable energy use rate. The user terminal may further control data transmission on per-communication data basis according to a level of priority of the communication data.

According to the embodiment described above, after handover to the second base station, the user terminal is able to perform communication using the data rate or data amount that is according to the renewable energy use rate of the second base station. Accordingly, for example, a greater amount of communication data may be transmitted/received via the second base station as the renewable energy use rate of the second base station is higher, and a smaller amount of communication data may be transmitted/received via the second base station as the renewable energy use rate of the second base station is lower. The use rate of renewable energy may thus be increased for the entire communication system.

Another embodiment of the present disclosure is a base station including a controller configured to issue a notification to a user terminal regarding a renewable energy use rate, and cause the user terminal to perform selection of a base station or control of data transmission based on the renewable energy use rate. As in the case described above, the renewable energy use rate may be any of the actual value, the predicted value, and a combination thereof. A method of notification of the renewable energy use rate from the base station to the user terminal is not particularly specified, and it is conceivable to include the renewable energy use rate in a part of a message that is transmitted by an existing system or in a new message, for example. The controller may transmit the renewable energy use rate to the user terminal by including the same in at least one of a system information block (SIB), a response to an initial access request, and a connection setting notification, for example.

The user terminal may preferentially select a base station with a higher renewable energy use rate as a connection target base station. “Preferential selection” means that a base station with a higher renewable energy use rate is selected when other conditions are the same, and does not mean to exclude selection of a base station in the light of factors other than the renewable energy use rate. An example of the factors that are used to select a base station other than the renewable energy use rate is the reception strength of a signal from the base station at the user terminal.

Furthermore, the user terminal may transmit a greater amount of data via a base station as the renewable energy use rate of the base station is higher. Furthermore, the user terminal may transmit even data with a lower level of priority via a base station as the renewable energy use rate of the base station is higher. In other words, in the case where the renewable energy use rate of a base station is low, the user terminal may transmit, via the base station, only data with a relatively high level of priority.

According to the present embodiment, the user terminal performs data communication by preferentially using a base station with a high renewable energy use rate, and the renewable energy use rate of the entire communication system may be increased.

In the following, embodiments of the present disclosure will be described with reference to the drawings. Configurations of the embodiments below are merely examples, and the present disclosure is not limited to the configurations of the embodiments.

### First Embodiment

(System Configuration)

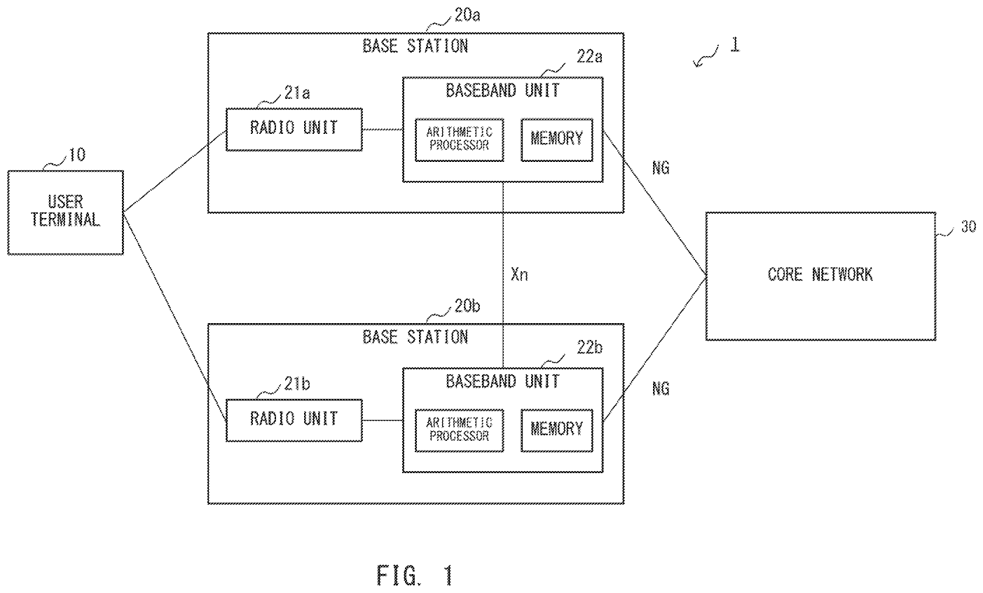

FIG. 1 is a diagram illustrating an example of a system configuration of a wireless communication system 1 according to a first embodiment. The wireless communication system 1 includes a user terminal 10, base stations 20a, 20b, and a core network 30. In the following, a description is given assuming that the wireless communication system according to the first embodiment is a 5G stand-alone system, but the wireless communication system 1 may alternatively be a system adopting any wireless communication method such as a 5G non-standalone system (combined use of 4G and 5G), 4G, 3G, or a wireless LAN.

The base station 20a includes a radio unit 21a and a baseband unit 22a. The radio unit 21a is in charge of wireless transmission/reception and sub-functions of a wireless physical layer, and transmits/receives radio waves to/from the user terminal 10 and performs analog-digital conversion on signals. The baseband unit 22a is in charge of functions related to radio resource allocation (MAC), retransmission control (RLC), packet encryption (PDCP), and radio resource control (RRC) of a terminal. Additionally, the functions of the baseband unit 22a may be implemented by being distributed across a plurality of units (such as a distributed unit (DU) and a central unit (CU)). Moreover, the radio unit 21a and the baseband unit 22a (or the DU and the CU) may be installed at physically separated locations or at a same location. The baseband unit 22a (or the DU and the CU) includes an arithmetic processor such as a CPU, a memory (a main memory), an auxiliary memory, a communication interface and the like, and the functions thereof are implemented by the arithmetic processor executing computer programs. The arithmetic processor is an example of the controller of the present disclosure.

The base station 20b includes a radio unit 21b and a baseband unit 22b. A configuration of the base station 20b is the same as that of the base station 20a, and description thereof will be omitted. Additionally, in the following description, in the case of giving a general description of the base station, a suffix (a or b) of the reference sign may be omitted.

The baseband unit 22a of the base station 20a and the baseband unit 22b of the base station 20b are connected by an Xn interface. However, depending on the base station 20, there may be no direct connection with the baseband unit 22 of another base station 20.

The core network 30 performs authentication of the user terminal 10, location management of the user terminal 10, policy control, packet transfer control, establishment of a communication path, and exchange of data with an external network. The core network 30 is connected to the base station 20a and the base station 20b by NG (N2/N3) interfaces. The core network 30 is also connected to an external network such as the Internet or a mobile carrier. More specifically, the core network 30 includes functions of a control plane and functions of a user plane. The functions of the control plane include an access and mobility management function (AMF) of performing connection/movement management of the user terminal 10, a session management function (SMF) of performing management of a session on the user plane, and unified data management (UDM) of managing subscriber information. The user plane exchanges user data with the user terminal by connecting to the base station and an external network.

The user terminal 10 is a terminal including a 5G wireless communication function, and is typically a smartphone terminal, a tablet terminal, or a personal computer. The user terminal 10 includes a wireless communication unit and an information processing unit, and connects to the base station 20 and performs wireless communication by using the wireless communication unit.

### Example 1 of Handover Process

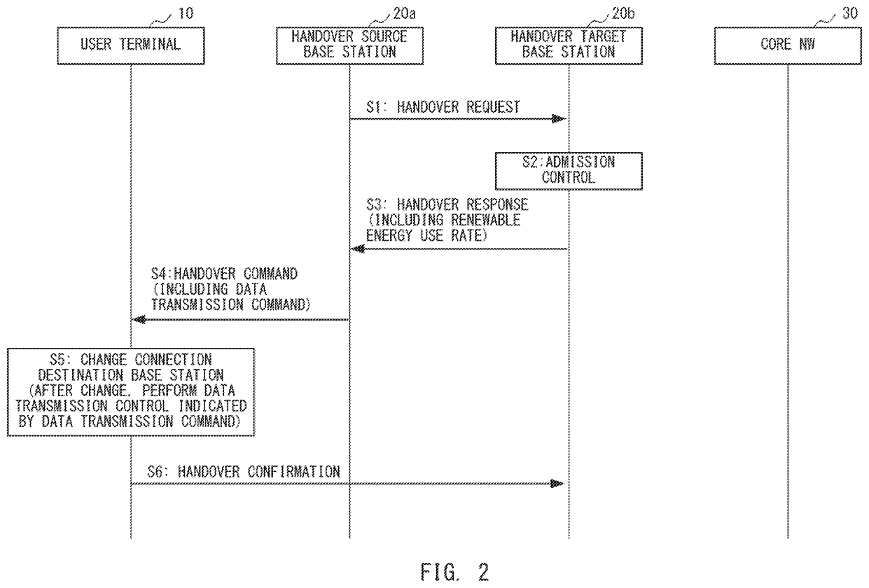

FIG. 2 is a diagram illustrating an example of a handover process. In this example, handover of the user terminal 10 from the base station 20a to the base station 20b is assumed. In the following, the base station 20a is referred to also as a handover source base station (or a source base station), and the base station 20b is referred to also as a handover target base station (a target base station).

Moreover, FIG. 2 illustrates the handover process where the handover source base station 20a and the handover target base station 20b are capable of communicating with each other directly (or without using the core network 30).

The handover process illustrated in FIG. 2 is started when the handover source base station 20a determines that handover of the user terminal 10 to the handover target base station 20b is required. Determination by the handover source base station 20a of whether handover is required or not is performed in the following manner. The user terminal 10 measures a reception strength of a signal transmitted from a base station in the neighborhood, and transmits a measurement result to the base station to which the user terminal 10 is currently connected (the handover source base station 20a). In the case where the reception strength of a signal from another base station exceeds a threshold, the handover source base station 20a determines that handover to the other base station is required. Additionally, the threshold is the reception strength of a signal from the handover source base station 20a, for example. In the case where the reception strengths of signals from a plurality of base stations are greater than the threshold, the base station of the greatest reception strength is identified as the handover target base station.

When the handover process is started, in step S1, the baseband unit 22a of the handover source base station 20a transmits a handover request to the baseband unit 22b of the handover target base station 20b.

In step S2, the baseband unit 22b of the handover target base station 20b performs admission control in response to reception of the handover request from the handover source base station 20a. The admission control is a process of securing radio resources according to a state of a network, and of controlling communication according to the state. The baseband unit 22b of the handover target base station 20b also acquires a renewable energy use rate of the handover target base station 20b. The renewable energy use rate is information indicating how much of energy used by the handover target base station 20b is renewable energy, and may be an actual value or a predicted value. The actual value and the predicted value may each take an immediately preceding value or an average value over an immediately preceding predetermined period of time (such as 1 minute, 15 minutes, 30 minutes, 1 hour, 3 hours, or 24 hours). The actual value of the renewable energy use rate may be acquired in the following manner, for example. The baseband unit 22b saves in a memory, at predetermined time intervals, an amount of used energy in such a manner that renewable energy and other types of energy (exhaustible energy) are distinguishable from each other. Furthermore, the baseband unit 22b calculates the renewable energy use rate based on a total amount of energy and an amount of renewable energy used in the immediately preceding predetermined period of time. Moreover, the predicted value of the renewable energy use rate may be obtained from a predicted value of an amount of generation of the renewable energy (an obtainable amount) and a predicted value of a total amount of energy consumption. The predicted values of the amount of generation of the renewable energy and the energy consumption may be predicted based on past performance, for example. Moreover, the predicted value of the amount of generation of the renewable energy may be predicted by also taking into account weather forecast (a predicted amount of sunlight in the case of solar power generation, and a predicted amount of wind power in the case of wind power generation).

In step S3, the baseband unit 22b of the handover target base station 20b transmits a handover response (Handover Request Acknowledgement) including the renewable energy use rate to the baseband unit 22a of the handover source base station 20a.

In step S4, in response to reception of the handover response, the baseband unit 22a of the handover source base station 20a transmits to the user terminal 10 a handover command instructing handover to the handover target base station 20b. The handover source base station 20a thus causes the user terminal 10 to perform handover. For example, the handover command may be an RRC Reconfiguration message instructing wireless connection to the handover target base station 20b. At the same time, the baseband unit 22a transmits to the user terminal 10, together with the handover command, a command related to data transmission after handover of the user terminal 10 (hereinafter referred to also as a data transmission control command). The data transmission control command includes information indicating at how much data rate or data amount the user terminal 10 is to perform communication after handover. The data rate or data amount after handover may be determined based on the renewable energy use rate. For example, the baseband unit 22b may save, in the memory, a correspondence table or a calculation formula for determining the amount of data transmission from a value of the renewable energy use rate, and may determine the data rate of data amount based on the table or the calculation formula and the renewable energy use rate. Alternatively, the handover source base station 20a may include the renewable energy use rate in the handover response and transmit the same to the user terminal 10, and the user terminal 10 may determine at how much data rate or data amount it performs transmission after handover.

In step S5, in response to reception of the handover command from the handover source base station 20a, the user terminal 10 changes a connection target base station from the base station 20a to the base station 20b. After changing the connection destination, the user terminal 10 performs transmission control such that transmission is performed by the data rate or data amount included in the data transmission control command. Alternatively, in the case where the renewable energy use rate is received by the user terminal 10, the user terminal 10 performs transmission control such that transmission is performed at the data rate or data amount according to the renewable energy use rate. In the case where the user terminal 10 has to suppress the data rate or data amount after handover, communication with a low level of priority may be stopped or throughput may be reduced. As an example of a method of reducing the throughput, shaping (buffering packet exceeding a bandwidth upper limit and transmitting afterward) may be cited. Furthermore, depending on contents of communication, policing (discarding a packet exceeding the bandwidth upper limit) may also be adopted. Moreover, in the case of communication of an image, a moving image, or audio, communication may be performed while reducing a part or all of image quality/sound quality and frame rate/sampling rate. Moreover, the user terminal 10 may take a level of priority of communication data into account, and may reduce throughput of communication with a low level of priority such as a log or entertainment without changing communication regarding autonomous driving with a high level of priority, for example. In contrast, in the case where the renewable energy use rate of the handover target base station 20b is higher than the renewable energy use rate of the handover source base station 20a, control may be performed such that communication is performed while increasing the throughput.

In step S6, the user terminal 10 transmits a handover confirmation (Handover Confirm) indicating that handover is complete, to the handover target base station 20b. For example, the handover confirmation may be an RRC Reconfiguration Complete message.

The process of handover of the user terminal 10 from the handover source base station 20a to the handover target base station 20b is completed by the process described above.

### Example 2 of Handover Process

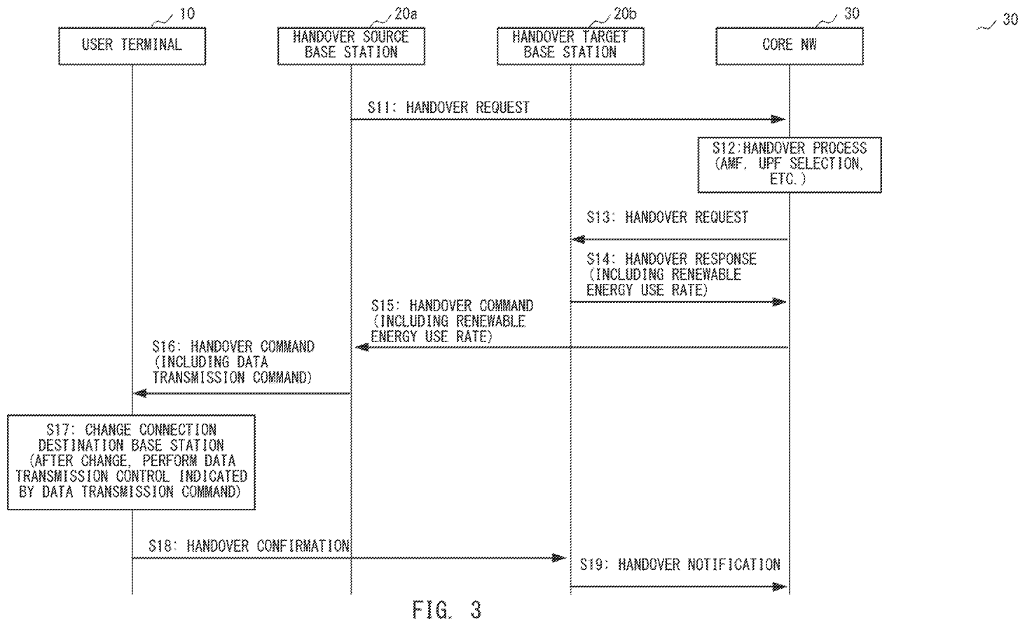

FIG. 3 is a diagram illustrating another example of the handover process. Also in this example, handover of the user terminal 10 from the base station 20a to the base station 20b is assumed. The present example is the handover process in a case where the handover source base station 20a and the handover target base station 20b are not connected by the Xn interface and are not capable of directly communicating with each other.

The handover process illustrated in FIG. 3 is started when the handover source base station 20a determines that handover of the user terminal 10 to the handover target base station 20b is necessary. Determination of whether handover is required or not is performed in the same manner described above, and repeated description will be omitted.

When the handover process is started, in step S11, the baseband unit 22a of the handover source base station 20a transmits a handover request (Handover Required) to the core network 30. Additionally, the process may be taken as transmission of the handover request from the handover source base station 20a to the handover target base station 20b that is performed via the core network 30.

In step S12, the core network 30 performs the handover process in response to the handover request from the handover source base station 20a. The handover process here includes selection of AMF and UPF, for example.

In step S13, the core network 30 transmits the handover request to the handover target base station 20b.

In step S14, the handover target base station 20b transmits the handover response (Handover Acknowledgement) including the renewable energy use rate to the core network 30. Details of the renewable energy use rate are given above, and repeated description will be omitted.

In step S15, the core network 30 transmits the handover command including the renewable energy use rate to the handover source base station 20a.

In step S16, in response to reception of the handover command, the handover source base station generates the data transmission control command according to the renewable energy use rate, and transmits the handover command including the data transmission control command to the user terminal 10.

In step S17, in response to reception of the handover command from the handover source base station 20a, the user terminal 10 changes the connection target base station from the base station 20a to the base station 20b. After changing the connection destination, the user terminal 10 performs transmission control such that transmission is performed at the data rate or data amount included in the data transmission control command. The process is as described above, and detailed description will be omitted.

In step S18, the user terminal 10 transmits the handover confirmation (Handover Confirm) indicating that handover is complete, to the handover target base station 20b.

In step S19, in response to reception of the handover confirmation, the handover target base station 20b transmits a handover notification (Handover Notify) to the core network 30.

The process of handover of the user terminal 10 from the handover source base station 20a to the handover target base station 20b is completed by the process described above.

Additionally, it suffices if the user terminal is able to perform data transmission at the data rate or data amount according to the renewable energy use rate of the base station after handover, and the process of determining the data rate or data amount after handover based on the renewable energy use rate may be performed by any of the handover source base station 20a, the handover target base station 20b, and the user terminal 10.

### Effect of Present Embodiment

According to the present embodiment, the user terminal performs communication by the amount of data transmission that is according to the renewable energy use rate of the base station that is the handover destination. Accordingly, the higher the renewable energy use rate of the base station, the greater the amount of data communication is performed, and the use rate of the renewable energy may be increased for the entire communication system.

### Second Embodiment

In a present embodiment, the renewable energy use rate is notified to the user terminal by the base station, and the user terminal is caused to perform selection of the connection target base station based on the renewable energy use rate.

An overall configuration of the communication system and configurations of the base station and the user terminal are the same as those in the first embodiment (FIG. 1), and repeated description will be omitted.

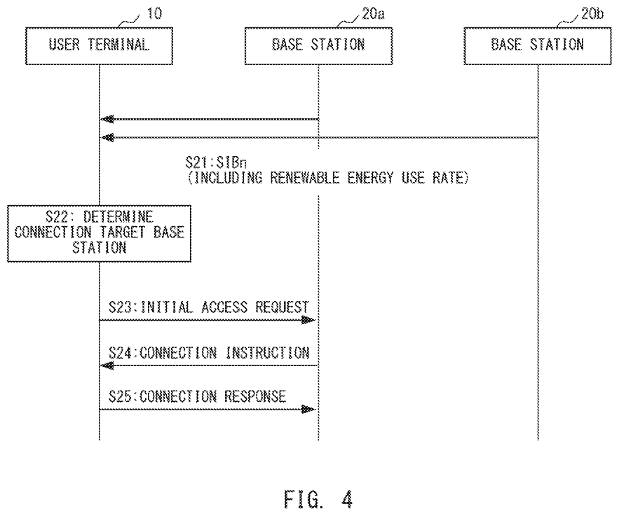

FIG. 4 illustrates a process of selecting the connection target base station at a time of activation (turning on of power) of the user terminal 10.

In step S21, the user terminal 10 receives SIBs from a plurality of base stations 20a, 20b in the neighborhood. Each base station 20 regularly transmits broadcast information called master information block (MIB) and system information block (SIB). The MIB is transmitted through a broadcast channel (BCH), and the MIB stores information for receiving the SIB. The SIB may include SIB1 to SIB21 that are each transmitted through a shared channel (DL-SCH). The SIB1 stores information for receiving the SIB2 to the SIB21, and the SIB2 to the SIB21 include information about the base station 20, such as an operator identification number, a band number, a Cell ID for selecting the base station, and various radio-related parameters. Each base station 20 includes the renewable energy use rate of the base station 20 in at least one of the SIB2 to the SIB21, and transmits the same. In FIG. 4, the SIB storing the renewable energy use rate is indicated by SIBn. Details of the renewable energy use rate and the acquisition method are the same as in the first embodiment, and repeated description will be omitted. The user terminal 10 may receive the SIBn by receiving the MIB and the SIB1. Additionally, FIG. 4 illustrates only the two base stations 20a, 20b, but the user terminal 10 receives the MIB and the SIB from every base station 20 in the neighborhood.

In step S22, the user terminal 10 determines the connection target base station from the base stations 20 from which the MIBs and the SIBs are received. Here, the user terminal 10 preferentially selects, as the connection target base station, a base station with respect to which the renewable energy use rate included in the SIBn is higher. “Preferential selection” means that a base station with a higher renewable energy use rate is selected when other conditions are the same, and does not mean to exclude selection of a base station in the light of factors other than the renewable energy use rate. Accordingly, in an occasional case, the base station with the highest renewable energy use rate is not selected as the connection target base station. Factors used for selection of the connection target base station are an operator identifier of the base station, and the reception strength of a signal from the base station at the user terminal 10, for example. The user terminal 10 basically selects, as the connection target base station, a base station 20 of high reception strength among the base stations 20 having a predetermined operator identifier, and in the case where there are a plurality of base stations of about the same reception strength, the base station with the highest renewable energy use rate is selected. “About the same reception strength” may mean that the reception strengths are at or greater than a threshold, or that a difference between the reception strengths is at or below a threshold, for example. Furthermore, the user terminal 10 may select a base station for which an index (or score) that is calculated based on the reception strength and the renewable energy use rate is the highest. Here, a description is given assuming that the reception strengths of the base station 20a and the base station 20b are about the same but the renewable energy use rate of the base station 20a is higher than that of the base station 20b, and that the base station 20a is selected as the connection target base station by the user terminal 10.

In step S23, the user terminal 10 transmits an initial access request (RRC Connection Request) to the base station 20a that is selected. More specifically, transmission of the initial access request is performed after transmission of PRACH (Physical Random Access CHannel) and reception of a response in relation to the same.

In step S24, in response to reception of the initial access request, the base station 20a transmits a connection instruction (RRC Setup) including information necessary for connection establishment, to the user terminal 10.

In step S25, in response to reception of the connection instruction, the user terminal 10 performs connection to the base station 20a according to the connection instruction, and transmits a connection complete message (RRC Setup Complete) to the base station 20a when connection is complete.

Connection to the base station at the time of activation of the user terminal 10 is thus completed.

According to the present embodiment, the user terminal 10 preferentially connects to a base station with a high renewable energy use rate, and a base station with a higher renewable energy use rate is thereby used for communication. Accordingly, the renewable energy use rate of the entire communication system may be increased.

### Third Embodiment

In a present embodiment, the base station transmits the renewable energy use rate by including the same in the response to the initial access request from the user terminal, and the user terminal is caused to perform control of data transmission based on the renewable energy use rate of the base station.

The overall configuration of the communication system and the configurations of the base station and the user terminal are the same as those in the first embodiment (FIG. 1), and repeated description will be omitted.

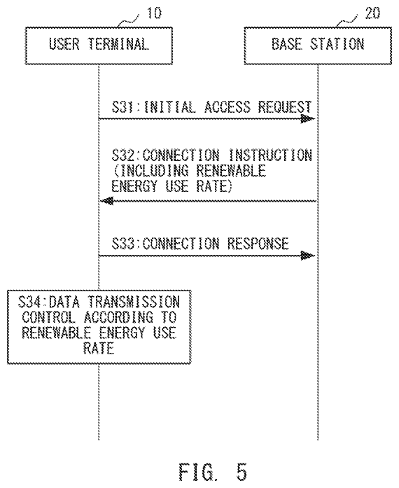

FIG. 5 illustrates a connection process at the time of connection of the user terminal 10 to the base station 20.

In step S31, the user terminal 10 transmits the initial access request (RRC Connection Request) to the base station 20. More specifically, transmission of the initial access request is performed after transmission of PRACH (Physical Random Access CHannel) and reception of a response in relation to the same.

In step S32, in response to reception of the initial access request, the base station 20 transmits the connection instruction (RRC Setup) including information necessary for connection establishment, to the user terminal 10. At the same time, the base station 20 transmits the renewable energy use rate of the base station 20 by including the same in the connection instruction. Details of the renewable energy use rate and the acquisition method are the same as those in the first embodiment, and repeated description will be omitted.

In step S33, in response to reception of the connection instruction, the user terminal 10 performs connection to the base station 20 according to the connection instruction, and transmits the connection complete message (RRC Setup Complete) to the base station 20 when connection is complete. Furthermore, the user terminal 10 saves, in a memory, the renewable energy use rate of the base station 20 that is included in the connection instruction.

In step S34, the user terminal 10 performs transmission control in such a way that transmission is performed at the data rate or data amount according to the renewable energy use rate of the base station 20 that is saved in the memory. The method of determining the data rate or data amount based on the renewable energy use rate and the method of controlling the amount of data transmission are the same as those in the first embodiment, and repeated description will be omitted.

According to the present embodiment, the user terminal performs communication at the data rate or data amount according to the renewable energy use rate of the connection target base station. Accordingly, the higher the renewable energy use rate of the base station, the greater the amount of data communication is performed, and the use rate of the renewable energy may be increased for the entire communication system.

According to the present embodiment, the base station 20 transmits the renewable energy use rate by including the same in the response to the initial access request, but the amount of data transmission based on the renewable energy use rate may be included and transmitted instead of the renewable energy use rate. The same effect is also obtained in this case.

In the case where the present embodiment is combined with the second embodiment, the renewable energy use rate does not have to be included in the response to the initial access request. This is because the user terminal 10 is able to determine the amount of data transmission based on the renewable energy use rate that is included in the SIBn.

### Fourth Embodiment

In a present embodiment, the base station transmits the renewable energy use rate to the user terminal by including the same in the connection setting notification, and the user terminal is caused to perform control of data transmission based on the renewable energy use rate of the base station.

The overall configuration of the communication system and the configurations of the base station and the user terminal are the same as those in the first embodiment (FIG. 1), and repeated description will be omitted.

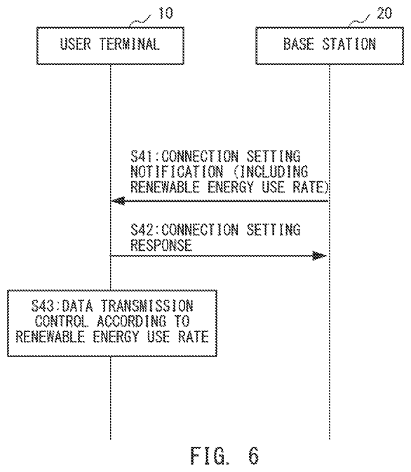

FIG. 6 illustrates a process at the time of transmission of the connection setting notification from the base station 20 to the user terminal 10.

In step S41, in the case where there is a change in available radio resources, the base station 20 transmits the connection setting notification to the user terminal 10. For example, the connection setting notification is a radio resource setting notification (RRC Reconfiguration). At the same time, the base station 20 transmits the renewable energy use rate of the base station 20 by including the same in the connection setting notification. Details of the renewable energy use rate and the acquisition method are the same as those in the first embodiment, and repeated description will be omitted. Additionally, the “change in available radio resources” includes a change in the renewable energy use rate of the base station 20.

In step S42, in response to reception of the connection setting notification, the user terminal 10 changes connection settings related to the base station 20 according to the connection setting notification, and transmits a connection setting response to the base station 20 when change is complete. For example, the connection setting response is an RRC Reconfiguration Acknowledgement message. Furthermore, the user terminal 10 saves, in the memory, the renewable energy use rate of the base station 20 that is included in the connection setting notification.

In step S43, the user terminal 10 performs transmission control in such a way that transmission is performed at the data rate or data amount according to the renewable energy use rate of the base station 20 that is saved in the memory. The method of determining the data rate or data amount based on the renewable energy use rate and the method of controlling the amount of data transmission are the same as those in the first embodiment, and repeated description will be omitted.

According to the present embodiment, the user terminal performs communication at the data rate or data amounts according to the renewable energy use rate of the connection target base station. Furthermore, when the renewable energy use rate of the connection target base station changes, the user terminal performs communication at the data rate of data amount according to the new renewable energy use rate. Accordingly, the higher the renewable energy use rate of the base station, the greater the amount of data communication is performed, and the use rate of the renewable energy may be increased for the entire communication system.

According to the present embodiment, the base station 20 transmits the renewable energy use rate by including the same in the connection setting notification, but the data rate or data amount based on the renewable energy use rate may be included and transmitted instead of the renewable energy use rate. The same effect is also obtained in this case.

Additionally, the connection setting notification or the RRC Reconfiguration message is transmitted from the handover target base station to the user terminal also after handover. The handover target base station may transmit the renewable energy use rate by including the same in the connection setting notification or the RRC Reconfiguration message after handover. In the present embodiment, the same effect as that of the first embodiment may thereby be obtained.

### Other Modifications

The embodiments described above are merely examples, and the present disclosure may be changed as appropriate within the scope of the disclosure.

Moreover, in relation to the description above, connection between the handover source base station 20a, the handover target base station 20b, and the core network 30 may be performed through one or more different apparatuses.

The processes and structure described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. A communication system comprising a first base station that includes a first controller and a second base station that includes a second controller, wherein
the first controller is configured to transmit a handover request to the second base station in a case where handover of a user terminal to the second base station is required,
the second controller is configured to transmit a handover response to the first base station in response to reception of the handover request, the handover response including a renewable energy use rate of the second base station, and
the first controller is configured to transmit a handover command to the user terminal in response to reception of the handover response, the handover command including the renewable energy use rate or a data transmission control command according to the renewable energy use rate.

2. The communication system according to claim 1, wherein the renewable energy use rate is based on an actual value of the renewable energy use rate of the second base station at a time point of transmission of the handover response or a predicted value of the renewable energy use rate of the second base station after the time point of transmission of the handover response.

3. The communication system according to claim 1, wherein the user terminal is configured to control data transmission based on the renewable energy use rate or the data transmission control command after handover to the second base station.

4. The communication system according to claim 3, wherein the user terminal is configured to control data transmission according to a level of priority of communication data, in a case where an amount of data transmission is to be suppressed after handover to the second base station.

5. A base station comprising a controller configured to issue a notification to a user terminal regarding a renewable energy use rate, and to cause the user terminal to perform selection of a base station or control of data transmission based on the renewable energy use rate.

6. The base station according to claim 5, wherein the renewable energy use rate is based on an actual value of the renewable energy use rate of the base station at a time point of issuing the notification or a predicted value of the renewable energy use rate of the base station after the time point of issuing the notification.

7. The base station according to claim 5, wherein the controller is configured to transmit the renewable energy use rate to the user terminal by including the renewable energy use rate in at least one of a system information block (SIB), a response to an initial access request, and a connection setting notification.

8. The base station according to claim 5, wherein selection of a base station or control of data transmission based on the renewable energy use rate includes preferentially selecting a base station with a higher renewable energy use rate.

9. The base station according to claim 5, wherein selection of a base station or control of data transmission based on the renewable energy use rate includes transmitting a greater amount of data via the base station as the renewable energy use rate of the base station is higher.

10. The base station according to claim 5, wherein selection of a base station or control of data transmission based on the renewable energy use rate includes transmitting even data with a lower level of priority via the base station as the renewable energy use rate of the base station is higher.

11. A communication method comprising:
a step, performed by a first base station, of transmitting a handover request to a second base station in a case where handover of a user terminal to the second base station is determined to be necessary;
a step, performed by the second base station, of transmitting a handover response to the first base station in response to reception of the handover request, the handover response including a renewable energy use rate of the second base station; and
a step, performed by the first base station, of transmitting a handover command to the user terminal in response to reception of the handover response, the handover command including the renewable energy use rate or a data transmission control command according to the renewable energy use rate.

12. A communication method comprising a step of causing a user terminal to perform selection of a base station or control of data transmission based on a renewable energy use rate, based on notification of the renewable energy use rate to the user terminal by a base station.
